(19) United States
(12) Patent Application Publication
(10) Pub. No.: US 2025/0173469 A1
(43) Pub. Date: May 29, 2025

(54) METHOD FOR CONSTRUCTING SIMULATION MODEL FOR ROADBED DISEASES, TEST METHOD, AND SYSTEM

(71) Applicant: SHANGDONG UNIVERSITY, Jinan (CN)

(72) Inventors: Jianqing WU, Jinan (CN); Zhiheng CHENG, Jinan (CN); Xiaobin XU, Jinan (CN); Cong DU, Jinan (CN); Hongbo ZHANG, Jinan (CN); Xiuguang SONG, Jinan (CN); Mingzhao WEI, Jinan (CN); Yuan TIAN, Jinan (CN); Xiaochao WANG, Jinan (CN)

(73) Assignee: SHANGDONG UNIVERSITY, Jinan (CN)

(21) Appl. No.: 18/435,260

(22) Filed: Feb. 7, 2024

(30) Foreign Application Priority Data
Nov. 29, 2023 (CN) 2023116232525

(51) Int. Cl. G06F 30/10; E01C 23/01

(52) U.S. Cl. CPC G06F 30/10; E01C 23/01

(57) ABSTRACT

A method, belonging to the field of road disease prevention technologies, for constructing a simulation model for roadbed diseases, a test method, and a system, where a simulation model for roadbed diseases is first constructed, and based on the model, an experimental method is performed to simulate diseases such as roadbed settlement, cracks, loosening, and pipeline breakage. Data of multi-sensing devices is associated with different diseases in different control groups, data statuses of various roadbed diseases in complex scenarios are acquired, and data patterns are summarized through control tests, to obtain sensor thresholds when the diseases occur in actual roadbed conditions, thereby providing a basis for road disease prevention.

### TECHNICAL FIELD

The present disclosure belongs to the field of road disease prevention technologies, and in particular, relates to a method for constructing a simulation model for roadbed diseases, a test method, and a system.

### BACKGROUND

The statements in this section merely provide background technical information related to the present disclosure and do not necessarily constitute prior art.

With the rapid development of transportation, road network construction is becoming more and more important. The stability and safety of roadbed structures have become the key to ensuring smooth road transportation and the safety of people's lives and property.

Nowadays, the situation of roadbed diseases is becoming increasingly severe. With the continuous development of transportation and the increase of vehicle load, roadbed diseases have brought huge challenges to road safety and sustainable development. Currently, common roadbed diseases include roadbed settlement, loosening, and cracking, pipeline leakage, and the like.

The commonly used method for simulating roadbed diseases is to use scaled model tests to study roadbed diseases. Indoor loading and performance status sensing are usually performed based on a reduced-size solid model of a roadbed structure to simulate load, environment, and disease impacts in real transportation conditions, to assess the performance status of the roadbed structure.

The inventor found that conventional roadbed disease simulation has the following technical defects: Influencing factors cannot be comprehensively considered: conventional experiments can often only consider one or two disease factors, and it is difficult to comprehensively consider various possible influencing factors. Data acquisition is difficult: During an experiment, it is difficult to obtain relevant data on roadbed diseases, and disease formation mechanisms and rules cannot be fully understood.

### SUMMARY

To solve at least one technical problem existing in the foregoing background technology, the present disclosure provides a method for constructing a simulation model for roadbed diseases, a test method, and a system, where a simulation model for roadbed diseases is first constructed, and based on the model, an experimental method is performed to simulate diseases such as roadbed settlement, cracks, loosening, and pipeline breakage. Data of multi-sensing devices is associated with different diseases in different control groups, data statuses of various roadbed diseases in complex scenarios are acquired, and data patterns are summarized through control tests, to accurately identify disease types.

To achieve the foregoing objective, the present disclosure adopts the following technical solutions:

A first aspect of the present disclosure provides a method for constructing a simulation model for roadbed diseases, the method including:
determining a material of each of a surface layer, an upper base layer, a lower base layer, and a soil base layer in a to-be-constructed model according to properties of each layer of an actual road;
determining a thickness, a vehicle load loading manner, and a boundary condition of each layer based on the material of each of the surface layer, the upper base layer, the lower base layer, and the soil base layer in the to-be-constructed model;
determining installation orientations and a quantity of sensors based on working principles of various sensors and frequent layers of various diseases; and
obtaining a simulation model for roadbed diseases through assembling based on the material, the thicknesses, the vehicle load loading manner, and the boundary condition of each layer, and the installation orientations and the quantity of sensors.

Further, the materials of the surface layer, the upper base layer, the lower base layer, and the soil base layer in the to-be-constructed model are respectively as follows: the surface layer is only used as a force transmission structure, and uses an asphalt wood board as a replacement material; and the upper base layer, the lower base layer, and the soil base layer use materials used for original roads.

Further, the thicknesses, the vehicle load loading manner, and the boundary condition of each layer include:
before model construction, the upper base layer and the surface layer are bonded to simulate mutual mechanical properties between different layers;
when disease scenarios of pipeline leakage and water seepage are simulated, considering a material of a pipeline in actual working conditions, the pipeline is buried in the soil base layer; and with reference to a standard of pipeline burial depth, the pipeline is buried in the soil base layer; and
the loading manners are divided into two types: static load and dynamic load, and a dynamic load is applied to a test piece in a loading sequence of first static load and then dynamic load.

Further, the determining installation orientations and a quantity of sensors based on working principles of various sensors and frequent layers of various diseases includes:
using earth pressure cells for earth pressure parts of the soil base layer, the upper base layer, and the lower base layer, where the earth pressure cells are respectively buried in the middle of the upper base layer and the middle of the soil base;
acquiring strain between the layer in the model by using strain gauges, arranging a plurality of strain gauges at bonding points of the layers, and installing strain gauges in the center of the soil base to detect soil base strain;
using hygrometers to detect a water seepage disease due to pipeline rupture, and burying hygrometers in the soil base layer at different heights to detect a relationship between time and a position of water seepage;
installing one end of a displacement meter on the top of the surface layer, adding a circular iron piece to a lower probe of the displacement meter, and burying the iron piece between the surface layer and the upper base layer; and
folding a distributed optical fiber when installed, and constructing settlement and pressure of the overall model in cooperation with the earth pressure cells.

Further, the obtaining a simulation model for roadbed diseases through assembling based on the material, the thicknesses, the vehicle load loading manner, and the boundary condition of each layer, and the installation orientations and the quantity of sensors includes:
burying and assembling different types of sensors from bottom to top based on the material and the determined thickness of the soil base layer;
compacting the soil base layer, burying strain gauges at different positions at a preset distance from a center of the soil base layer surface, burying strain gauges at different positions at the preset distance from centers of the lower base layer surface and the upper base layer surface, and adding corresponding materials to the corresponding base layers for assembly, to complete assembly of the entire base layer; and
burying strain gauges at a specific distance from the center, burying displacement meter iron pieces at the specific distance from the center, connecting the iron pieces to the displacement meters, and finally covering with the surface layer material.

Further, a process of burying and assembling different types of sensors from bottom to top based on the material and the determined thickness of the soil base layer includes:
filling the soil base layer with silty sand of a first height and burying a simulated pipeline on a center line, respectively installing hygrometers at different distances from the simulated pipeline, continuously filling with silty sand of a second height, and respectively burying two hygrometers at a same longitudinal axis; and continuously filling with silty sand of a third height to reach the center of the soil base layer, burying earth pressure cells, burying strain gauges at different distances from the center, and finally filling with silty sand of a fourth height, to complete assembly of the soil base part.

A second aspect of the present disclosure provides a simulation test method for roadbed diseases, where a simulation test for roadbed diseases is carried out based on the simulation model for roadbed diseases constructed according to the first aspect, and the method includes:
obtaining various roadbed diseases by changing properties of the simulation model for roadbed diseases;
setting up a plurality of groups of control tests, where each group of control tests includes normal roadbed and various roadbed diseases;
acquiring sensor data under normal roadbed and various roadbed diseases; and
analyzing a relationship between the sensor data under normal roadbed and various roadbed diseases, and obtaining, through an analytic hierarchy process, sensor thresholds when the diseases occur in actual roadbed conditions.

Further, the obtaining various roadbed diseases by changing properties of the simulation model for roadbed diseases includes:
applying different loads at different positions of the model to implement uneven settlement diseases of the roadbed;
embedding cracked materials inside the model or using materials with different stiffness to simulate a crack disease of the roadbed;
using other soil or geotechnical materials to represent weak roadbed to simulate a loose disease of the roadbed; and
injecting water into a water pipe to ensure that the water can flow into the soil base model at which the water pipe breaks, to simulate a pipeline break disease.

Further, the acquired sensor data under the plurality of groups of normal roadbed and various roadbed diseases is averaged and then analyzed.

A third aspect of the present disclosure provides a simulation test system for roadbed diseases, the system including:
a disease obtaining module, configured to obtain various roadbed diseases by changing properties of a simulation model for roadbed diseases;
a data obtaining module, configured to: set up a plurality of groups of control tests, where each group of control tests includes normal roadbed and various roadbed diseases; and acquire sensor data under normal roadbed and various roadbed diseases; and
a test analysis module, configured to analyze a relationship between the sensor data under normal roadbed and various roadbed diseases, and obtain, through an analytic hierarchy process, sensor thresholds when the diseases occur in actual roadbed conditions.

Compared with the prior art, the present disclosure has the following beneficial effects:

1. According to the present disclosure, model testing and burying manners based on multi-source sensors are used, to more comprehensively simulate various roadbed diseases, and obtain accurate experimental data of the roadbed model.

2. According to the present disclosure, strain gauges and distributed optical fibers are respectively used to acquire strain at different layers. Similarly, there is an earth pressure cell at a corresponding point of the strain to detect the strain at each strain point. Combined with other instrument data, data of multi-sensing devices are associated with different diseases in different control groups to accurately identify disease types.

3. According to the present disclosure, a separate study is conducted on the pipeline leakage disease, the scenario of pipeline rupture and water seepage is simulated by using the same material at the actual burial depth, and the hygrometer is used to detect and perform data analysis on the simulated ruptured pipeline, thereby simulating an infiltration range and an infiltration speed of water flow in the soil base layer.

4. According to the present disclosure, roadbed diseases are created, one or more diseases can be simulated in a model tank. In this way, the data statuses of various roadbed diseases in complex scenarios can be acquired, and the data patterns can be summarized through control tests.

5. According to the present disclosure, the overall bearing capacity is used as the evaluation parameter, and model parameters are automatically adjusted through test data feedback, so that the model is closer to the actual situation, thereby more accurately evaluating the overall bearing capacity. Therefore, the roadbed model test provides a more accurate and comprehensive evaluation of the performance of the roadbed structure.

Advantages of additional aspects of the present disclosure are provided in part in the following description below and become obvious in part from the following description, or may be learned by practice of the present disclosure.

### BRIEF DESCRIPTION OF THE DRAWINGS

The accompanying drawings constituting a part of the present disclosure are used to provide a further understanding of the present disclosure. The exemplary embodiments of the present disclosure and descriptions thereof are used to explain the present disclosure, and do not constitute an improper limitation of the present disclosure.

FIG. 1 is a schematic flowchart of a method for constructing a simulation model for roadbed diseases according to an embodiment of the present disclosure;

FIG. 2 is a schematic diagram of composition of test pieces of layers according to an embodiment of the present disclosure;

FIG. 3 is a schematic diagram of a loading manner of a test piece according to an embodiment of the present disclosure;

FIG. 4 is a top view of a test piece load scenario according to an embodiment of the present disclosure;

FIG. 5 is a schematic diagram of arrangement of sensors at an overall layer according to an embodiment of the present disclosure;

FIG. 6 is a schematic diagram of arrangement of a distributed optical fiber according to an embodiment of the present disclosure; and

FIG. 7 is a schematic diagram of arrangement of a displacement meter according to an embodiment of the present disclosure.

### DETAILED DESCRIPTION

The present disclosure is further described below with reference to the accompanying drawings and embodiments.

It should be pointed out that the following detailed descriptions are all illustrative and are intended to provide further descriptions of the present disclosure. Unless otherwise specified, all technical and scientific terms used herein have the same meanings as those usually understood by a person of ordinary skill in the art to which the present disclosure belongs.

It should be noted that the terms used herein are merely used for describing specific implementations, and are not intended to limit exemplary implementations of the present disclosure. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

First, model testing provides an ideal platform for studying key factors in a performance status of a roadbed structure due to its controllability and efficiency. By constructing a model test apparatus, stress and deformation of an actual roadbed in different environmental conditions such as load, temperature, and humidity can be simulated, and impacts of various factors on the performance status of the roadbed structure can be monitored and recorded in real time. This provides an effective means for in-depth study of dynamic response and deformation laws of the roadbed structure.

The development mechanism of roadbed structure diseases can be revealed through model tests. During long-term use of the roadbed structure, various types of diseases occur, such as settlement, cracks, and deformation. Through model tests, the development process of such diseases can be simulated and accelerated, and causes, mechanisms, and evolution rules of occurrence of the diseases can be studied. This helps to determine and prevent the occurrence of the roadbed structure diseases in advance, improving road reliability and durability.

In addition, model tests can further explore a relationship between a change (such as settlement or strain) in the roadbed structure and a roadbed disease. The performance of the roadbed structure is comprehensively affected by many factors, such as soil properties, a roadbed thickness, and a pavement type. Through model tests, the extent and regularity of the impact on the performance status of the roadbed structure are analyzed, which provides a scientific basis for optimizing the design and construction of the roadbed structure, improving the safety and the load-bearing capacity of the roadbed structure.

In short, it is of great significance to study the performance status and the disease mechanism of the roadbed structure based on the model tests. The stress and deformation of the actual roadbed structure is simulated to reveal the disease development mechanism of the roadbed, which provides a scientific basis for optimizing the design and construction of the roadbed structure, and ensures the smooth flow of road traffic and the safety of people's lives and property. This plays a positive role in promoting road traffic construction and maintenance management.

In the present disclosure, in view of the current situation that there are few means of detecting the roadbed and few detection parameters, and detection causes damage to the roadbed, a model experimental method that can simulate diseases such as roadbed settlement, cracks, and loosening, and pipeline breakage is designed. According to different mechanical material properties of each road layer, materials with high performance similarity are used for replacement, so that the experiment is performed on test models basically the same as those in the actual situation. To reduce the influence of errors, three model tests are constructed for each working condition. dynamic loads and static loads are applied to 15 groups of model tests to acquire data. After each three groups of tests, an average is taken, to construct four groups of control tests. Finally, four different sensors are used to comprehensively evaluate performance of the roadbed.

### Embodiment 1

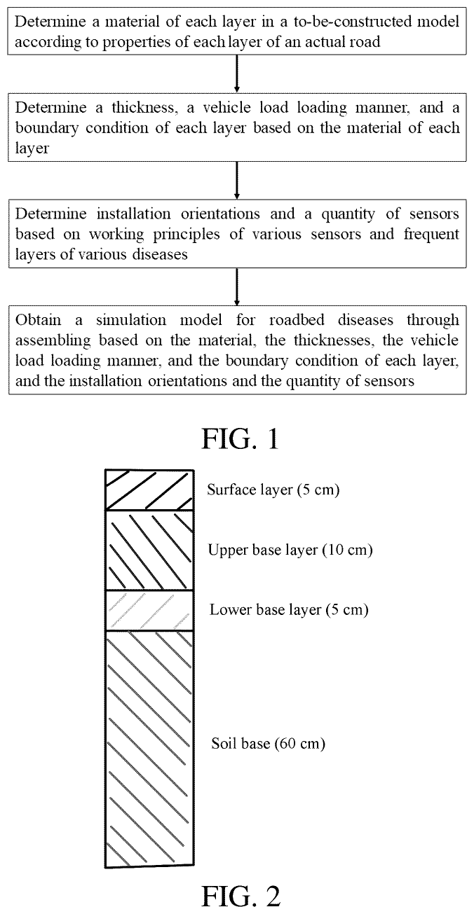

Refer to FIG. 1. This embodiment provides a method for constructing a simulation model for roadbed diseases, the method including:

Step 1: Determine a material of each of a surface layer, an upper base layer, a lower base layer, and a soil base layer in a to-be-constructed model according to properties of each layer of an actual road.

In step 1, according to this method, an asphalt wood board is used as the surface layer, cement-stabilized gravel is used as the upper base layer, cement soil is used as the lower base layer, and silty sand is used as the soil base part of the model experiment in model construction.

First, a scaled experiment is carried out according to road performance of each layer of an actual road. In terms of material selection for the surface layer, because the surface layer is only used as a force transmission structure, lower-cost asphalt wood boards are used as alternative materials, and the strength of actual working conditions can be simulated by controlling parameters such as a wood material, a thickness, and an asphalt thickness.

In the base layer (including the upper base layer and the lower base layer) and the soil base part, materials used in the original roadbed, including silty sand, cement soil, and cement-stabilized gravel, are used to prepare precast slabs.

When the upper base layer, namely, the cement-stabilized gravel slab, is prepared, it is necessary to bury earth pressure cells in advance during model pouring. After the cement-stabilized gravel slab is solidified, it is directly filled for use.

Specifically, to simulate a force transmission process of a pavement, an asphalt fir board of a specific thickness is used to simulate an effect of vehicle vibration when subjected to compressive load subsequently.

The cement-stabilized gravel is used for the upper base layer. A thickness, a size and a content of a gravel material, and a cement dosage are the same as those of an actual pavement structure, so that the strength is the same as an upper base layer in actual working conditions.

Cement-stabilized soil is selected for the lower base layer. Strength, stiffness, and other parameters are controlled to be the same as actual road performance parameters by controlling the gravel and cement content in the same proportion as the material of the lower base layer of the actual road.

The silty sand is used for the soil base, and a compaction degree of the soil base is controlled in the model.

Step 2: Determine a thickness, a vehicle load loading manner, and a boundary condition of each layer based on the material of each of the surface layer, the upper base layer, the lower base layer, and the soil base layer in the to-be-constructed model.

In step 2, a specific determination process includes:

Step 201: A loading module of this model test is a square pouring area of 1.2 m×1.2 m. It is necessary to prefabricate 1.2 m×1.2 m test pieces of layers. The asphalt wood board for the surface layer design is 5 cm, the cement-stabilized gravel is 10 cm, the thickness of cement soil is 5 cm, and the thickness of silty sand is 60 cm. FIG. 2 is a schematic diagram of the width of each layer.

Step 202: Because all test pieces except silty sand need to be prepared in advance rather than poured in one layer, emulsified asphalt needs to be used to bond the base layer and the surface layer before the model test. This method can simulate mutual mechanical properties between different layers.

Step 203: When disease scenarios of pipeline leakage and water seepage are simulated, considering a material of a pipeline in actual working conditions, a PVC pipeline is buried in the soil base layer; and with reference to a standard of pipeline burial depth, the pipeline is buried in the soil base layer.

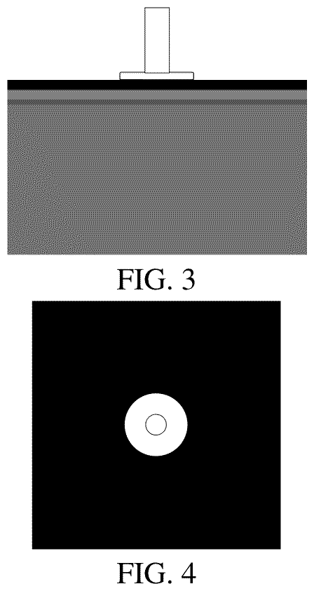

Step 204: The loading manners may be divided into two types: static load and dynamic load, and a dynamic load with a median value of 0.7 MPa, an amplitude of 30%, and a frequency of 3 is applied to a test piece in a loading sequence of first static load and then dynamic load. FIG. 3 and FIG. 4 are front and top views of the load scenario of the test piece.

Step 3: Determine installation orientations and a quantity of sensors based on working principles of various sensors and frequent layers of various diseases.

Step 3 specifically includes the following steps:

Step 301: Use earth pressure cells for earth pressure parts of the soil base and the base layer, where the earth pressure cells are respectively buried in the middle of the upper base layer and the middle of the soil base. Because earth pressure cells also need to be arranged in the center of the upper base layer, the earth pressure cells need to be buried in advance when the upper base layer is poured.

Step 302: Acquire strain between the layer in the model by using strain gauges, arrange a plurality of strain gauges at bonding points of the layers, and install strain gauges in the center of the soil base to detect soil base strain.

Step 303: Use hygrometers to detect a water seepage disease due to pipeline rupture, where because burial of pipelines is concentrated in the soil base part, hygrometers are buried in the soil base part at different heights to ensure that a relationship between time and a position of water seepage is detected.

Step 304: Because one end of a displacement meter needs to be fixed, and a distance after displacement is determined by moving the other end, one end of the displacement meter needs to be installed on the top, a circular iron piece is added to a lower probe of the displacement meter, and the iron piece is buried between the surface layer and the upper base layer.

Step 305: A distributed optical fiber needs to be folded when installed, to construct settlement and pressure of the overall model in cooperation with the earth pressure cells.

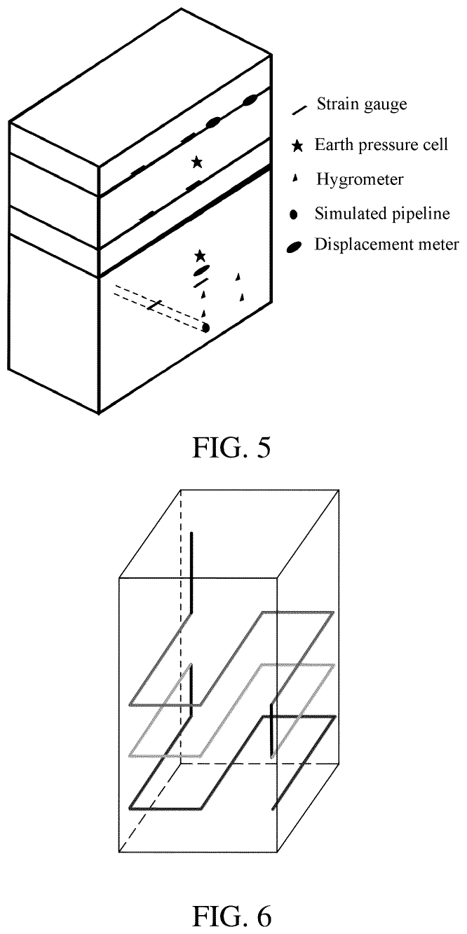

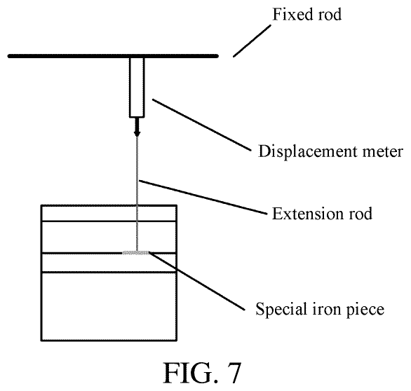

In a group of roadbed model tests, two earth pressure cells, eight strain gauges, four hygrometers, two displacement meters, and a 24 m distributed optical fiber are required. A schematic diagram of arrangement of an overall layer is shown in FIG. 5. A schematic diagram of burial of the distributed optical fiber is shown in FIG. 6. A schematic diagram of arrangement of the displacement meter is shown in FIG. 7. Because the displacement meter cannot be buried, an external placement method is used to fix the displacement meter on a fixed rod through an extension rod.

Step 4: Obtain a simulation model for roadbed diseases through assembling based on the material, the thicknesses, the vehicle load loading manner, and the boundary condition of each layer, and the installation orientations and the quantity of sensors.

In step 4, different types of sensors are buried during the construction of the model, specifically:

Step 401: After various boards are prepared, the model can be assembled in combination with the soil base. First, the model is filled with 20 cm of silty sand, and a PVC water pipe is buried on the center line. Hygrometers are respectively installed at distances of 5 cm and 25 cm from the PVC water pipe. 5 cm of silty sand is further filled, and two hygrometers are respectively buried at the same longitudinal axis. 5 cm of silty sand is further filled earth pressure cells are buried in the center, strain gauges are buried at 10 cm and 50 cm from the center, and finally 30 cm of silty sand is filled, to complete the soil base part.

Step 402: Compact the soil base part, bury two strain gauges on the surface of the soil base at 10 cm and 50 cm from the center, and then add a cement-soil slab.

Step 403: Bury two strain gauges at 10 cm and 50 cm from the center, and then add the upper base layer, that is, the cement-stabilized gravel slab, to complete assembly of the entire base layer.

Step 404: Bury two strain gauges at 10 cm and 50 cm from the center, and bury displacement meter iron pieces at 20 cm and 40 cm from the center and connect the iron pieces to the displacement meters. Finally, emulsified asphalt is used for covering, and a final layer of asphalt wood board is added.

The constructed model is used for tests in Embodiment 2.

### Embodiment 2

This embodiment provides a simulation test method for roadbed diseases, where a simulation test for roadbed diseases is carried out based on the simulation model for roadbed diseases constructed according to Embodiment 1, and the method includes:

Step 1: Obtain various roadbed diseases by changing properties of the simulation model for roadbed diseases.

Step 2: Set up a plurality of groups of control tests, where each group of control tests includes normal roadbed and various roadbed diseases.

Step 3: Acquire sensor data under normal roadbed and various roadbed diseases.

Step 4: Analyze a relationship between the sensor data under normal roadbed and various roadbed diseases, and obtain, through an analytic hierarchy process, sensor thresholds when the diseases occur in actual roadbed conditions.

In step 1, the obtaining various roadbed diseases by changing properties of the simulation model for roadbed diseases includes:

Step 101: For a model test piece in normal strength conditions, a dynamic load with a median value of 0.7 MPa, an amplitude of 30%, and a frequency of 3 is applied to the test piece in a loading sequence of first static load and then dynamic load, and data information of each sensor is acquired.

Step 102: When a crack disease is simulated, data is loaded and read by cutting cracks in the model to simulate different sizes and positions, or using materials with different stiffness.

Step 103: When a roadbed settlement disease is simulated, a load effect of the actual roadbed is simulated by controlling a compaction degree of the soil base; and static load or dynamic load can be used to apply loads to cause settlement deformation in the model, and then data is loaded and read.

Step 104: To simulate looseness of the roadbed, a low-density filler material (such as a lightweight filler) may be used or a degree of consolidation of the model may be reduced, and then data is loaded and read.

Step 105: When pipeline rupture is simulated, water is injected into the PVC pipeline in which a damage point is created, and experimental data starts to be loaded and read along with the water injection process.

It should be noted that, materials used for the asphalt wood board are asphalt and wood wool; for the upper base layer, 5% cement dosage is used to mix into cement-stabilized gravel; for the lower base layer, cement-stabilized soil (cement dosage 4%) is selected, and stiffness is changed by controlling whether to add gravel (30%); and for the soil base, silty sand is used, and a compaction degree (92% or 96%) can be controlled in the model.

In step 2, the control test design is made by previously changing the properties of the model to simulate the roadbed diseases, and the acquired data is processed and combined with the control test to determine a disease occurrence threshold.

In this embodiment, at least four groups of control tests are designed. Each group of control tests includes three test models in the same working conditions, namely, a normal roadbed strength experimental group, a crack experimental group, an uneven roadbed settlement group, a loose roadbed group, and a pipeline leakage group. Sensor data acquired from different disease groups is compared with that from the normal group to observe the impact of different road diseases on various sensors.

In step 3 and step 4, the principle of analyzing the acquired sensor data to obtain the sensor thresholds when the diseases occur in actual roadbed conditions is:

Roadbed settlement is usually a geological phenomenon in which ground elevation decreases in a specific area due to compression of loose strata caused by natural factors and human activities. The model test of this embodiment intends to use the static load at the longitudinal axis as the external factor to achieve indoor simulation of the settlement of the roadbed in the natural state. A vibrating wire settlement meter is used to sense and acquire a settlement value of the roadbed structure, which is analyzed as a key influencing factor of the performance status of the roadbed.

Looseness: It generally refers to looseness of the soil base or the base layer, and is also one of the main internal causes of roadbed settlement. The model test of this embodiment intends to use the soft soil base and the base layer structure to simulate looseness, and use the earth pressure cells to acquire the size and distribution of earth pressure, to reflect the loose disease, which is analyzed as a key influencing factor of the performance status of the roadbed.

Cracking: It generally refers to base layer cracking or reflection cracking, which mainly occurs below the surface layer and is a hidden disease of the road structure. The model test of this embodiment intends to use a manual cutting method to set cracks of different sizes and positions in the base layer to simulate a crack disease of the roadbed structure. In addition, because roadbed cracks cannot be acquired directly through visual methods, this model test uses a strain detection method to acquire roadbed cracks. The strain sensors are buried in the surface layer, the base layer, and the soil base layer, to sense strain distribution of the roadbed model structure under load. The distribution positions and degrees of the crack disease are determined based on structural mechanics analysis, finite element numerical simulation, and other methods, which is analyzed as a key influencing factor of the performance status of the roadbed.

Pipeline leakage and water level monitoring: It is a phenomenon of gas and liquid spillage caused by pipeline rupture. The model test of this embodiment uses the method of pre-burying water pipelines to simulate pipeline leakage and excessive moisture content of the soil base caused by rising water levels. The hygrometers or water level meters are used to monitor pipeline leakage and the moisture content of the soil base, which is analyzed as a key influencing factor of the performance status of the roadbed.

The foregoing descriptions are merely preferred embodiments of the present disclosure, but are not intended to limit the present disclosure. A person skilled in the art may make various alterations and variations to the present disclosure. Any modification, equivalent replacement, or improvement made within the spirit and principle of the present disclosure shall fall within the protection scope of the present disclosure.

1. A method for constructing a simulation model for roadbed diseases, the method comprising:
determining a material of each of a surface layer, an upper base layer, a lower base layer, and a soil base layer in a to-be-constructed model according to properties of each layer of an actual road;
determining a thickness, a vehicle load loading manner, and a boundary condition of each layer based on the material of each of the surface layer, the upper base layer, the lower base layer, and the soil base layer in the to-be-constructed model;
determining installation orientations and a quantity of sensors based on working principles of various sensors and frequent layers of various diseases; and
obtaining a simulation model for roadbed diseases through assembling based on the material, the thicknesses, the vehicle load loading manner, and the boundary condition of each layer, and the installation orientations and the quantity of sensors.

2. The method for constructing a simulation model for roadbed diseases according to claim 1, wherein the materials of the surface layer, the upper base layer, the lower base layer, and the soil base layer in the to-be-constructed model are respectively as follows: the surface layer is only used as a force transmission structure, and uses an asphalt wood board as a replacement material; and the upper base layer, the lower base layer, and the soil base layer use materials used for original roads.

3. The method for constructing a simulation model for roadbed diseases according to claim 1, wherein the thicknesses, the vehicle load loading manner, and the boundary condition of each layer comprise:
before model construction, the upper base layer and the surface layer are bonded to simulate mutual mechanical properties between different layers;
when disease scenarios of pipeline leakage and water seepage are simulated, considering a material of a pipeline in actual working conditions, the pipeline is buried in the soil base layer; and with reference to a standard of pipeline burial depth, the pipeline is buried in the soil base layer; and
the loading manners are divided into two types: static load and dynamic load, and a dynamic load is applied to a test piece in a loading sequence of first static load and then dynamic load.

4. The method for constructing a simulation model for roadbed diseases according to claim 1, wherein
the determining installation orientations and a quantity of sensors based on working principles of various sensors and frequent layers of various diseases comprises: using earth pressure cells for earth pressure parts of the soil base layer, the upper base layer, and the lower base layer, wherein the earth pressure cells are respectively buried in the middle of the upper base layer and the middle of the soil base;
acquiring strain between the layer in the model by using strain gauges, arranging a plurality of strain gauges at bonding points of the layers, and installing strain gauges in the center of the soil base to detect soil base strain;
using hygrometers to detect a water seepage disease due to pipeline rupture, and burying hygrometers in the soil base layer at different heights to detect a relationship between time and a position of water seepage;
installing one end of a displacement meter on the top of the surface layer, adding a circular iron piece to a lower probe of the displacement meter, and burying the iron piece between the surface layer and the upper base layer; and
folding a distributed optical fiber when installed, and constructing settlement and pressure of the overall model in cooperation with the earth pressure cells.

5. The method for constructing a simulation model for roadbed diseases according to claim 1, wherein the obtaining a simulation model for roadbed diseases through assembling based on the material, the thicknesses, the vehicle load loading manner, and the boundary condition of each layer, and the installation orientations and the quantity of sensors comprise:
burying and assembling different types of sensors from bottom to top based on the material and the determined thickness of the soil base layer;
compacting the soil base layer, burying strain gauges at different positions at a preset distance from a center of the soil base layer surface, burying strain gauges at different positions at the preset distance from centers of the lower base layer surface and the upper base layer surface, and adding corresponding materials to the corresponding base layers for assembly, to complete assembly of the entire base layer; and
burying strain gauges at a specific distance from the center, burying displacement meter iron pieces at the specific distance from the center, connecting the iron pieces to the displacement meters, and finally covering with the surface layer material.

6. The method for constructing a simulation model for roadbed diseases according to claim 5, wherein
a process of burying and assembling different types of sensors from bottom to top based on the material and the determined thickness of the soil base layer comprises:
filling the soil base layer with silty sand of a first height and burying a simulated pipeline on a center line, respectively installing hygrometers at different distances from the simulated pipeline, continuously filling with silty sand of a second height, and respectively burying two hygrometers at a same longitudinal axis; and continuously filling with silty sand of a third height to reach the center of the soil base layer, burying earth pressure cells, burying strain gauges at different distances from the center, and finally filling with silty sand of a fourth height, to complete assembly of the soil base part.

7. A simulation test method for roadbed diseases, wherein a simulation test for roadbed diseases is carried out based on the simulation model for roadbed diseases constructed according to claim 1, and the method comprises: obtaining various roadbed diseases by changing properties of the simulation model for roadbed diseases;
setting up a plurality of groups of control tests, wherein each group of control tests comprises normal roadbed and various roadbed diseases;
acquiring sensor data under normal roadbed and various roadbed diseases; and
analyzing a relationship between the sensor data under normal roadbed and various roadbed diseases, and obtaining, through an analytic hierarchy process, sensor thresholds when the diseases occur in actual roadbed conditions.

8. The simulation test method for roadbed diseases according to claim 7, wherein the obtaining various roadbed diseases by changing properties of the simulation model for roadbed diseases comprises:
applying different loads at different positions of the model to implement uneven settlement diseases of the roadbed;
embedding cracked materials inside the model or using materials with different stiffness to simulate a crack disease of the roadbed;
using other soil or geotechnical materials to represent weak roadbed to simulate a loose disease of the roadbed; and
injecting water into a water pipe to ensure that the water can flow into the soil base model at which the water pipe breaks, to simulate a pipeline break disease.

9. The simulation test method for roadbed diseases according to claim 7, wherein the acquired sensor data under the plurality of groups of normal roadbed and various roadbed diseases is averaged and then analyzed.

10. A simulation test system for roadbed diseases, the system comprising:
a disease obtaining module, configured to obtain various roadbed diseases by changing properties of a simulation model for roadbed diseases;
a data obtaining module, configured to: set up a plurality of groups of control tests, wherein each group of control tests comprises normal roadbed and various roadbed diseases; and acquire sensor data under normal roadbed and various roadbed diseases; and
a test analysis module, configured to analyze a relationship between the sensor data under normal roadbed and various roadbed diseases, and obtain, through an analytic hierarchy process, sensor thresholds when the diseases occur in actual roadbed conditions.
